(19) United States
(12) Patent Application Publication
(10) Pub. No.: US 2003/0211215 A1
(43) Pub. Date: Nov. 13, 2003

(54) Method and system for managing pizza dough ball proofing

(76) Inventors: John D. Correll, Canton, MI (US); Andrew Bounas, Milton, MA (US)

Correspondence Address: John D. Correll, 8459 Holly Dr., Canton, MI, 48187-4237, US

(21) Appl. No.: 10/144,482

(22) Filed: May 13, 2002

(51) Int. Cl. A21D 10/00

(52) U.S. Cl. 426/549

(57) ABSTRACT

A method and system whereby a pizza company that makes pizzas from dough balls can create and control an optimal rate of proofing development for a plurality of dough balls disposed in various points, or stages, of proofing development. The method comprises the steps of (1) providing a computer-based dough ball management algorithm incorporating a dough ball proofing-progression measurement system, (2) periodically transmitting into the algorithm one or more dough ball usage values and one or more dough ball proofing-point inventory values, (3) periodically receiving computer-generated dough ball management information from the algorithm, and (4) based on the information, moving a particular quantity of dough balls of a particular point of proofing development from a refrigerated environment to a warm-air environment, resulting in the dough balls reaching a level of optimal proofing development by the time that they're needed for making into pizzas. A system associated with the method is disclosed, that system typically comprising a refrigerated inventory of dough balls disposed in a sub-target point of proofing development, a computer system, and a particular dough ball management algorithm residing in the computer system.

### FIELD OF THE INVENTION

This invention relates in general to the field of baking and dough science and, in particular, to management of the proofing process of non-frozen pizza dough balls.

### BACKGROUND OF THE INVENTION

In the pizza industry there are various types of pizza dough handling systems. One such system is the dough ball commissary distribution system. In this system, dough balls are prepared in a central commissary by (a) mixing a batch of dough, then (b) dividing and rounding the dough into balls of predetermined weight, and, finally, (c) placing the dough balls into trays and moving the trays of balls into refrigeration.

After the dough balls have cooled to refrigerator temperature, the trays of balls are trucked to pizzeria outlets for use in making pizzas. Typically a commissary will make two to three shipments per week to an outlet. Once in the pizzeria, the trays of dough balls are stored in a refrigerator, from which they are withdrawn over a three to four day period for making into pizzas.

During this three to four day period the refrigerated dough balls are slowly but continuously “rising,” or undergoing fermentational development, due to the metabolic activity of the yeast within the dough. For any given pizza dough ball there is a level of optimal fermentational development at which point the dough ball produces a pizza crust of optimal eating characteristics (i.e., optimal rise, color, flavor, aroma, and texture). A dough ball that's either under-developed or over-developed in relation to the level of optimal fermentational development produces a pizza crust of sub-optimal eating characteristics.

In the pizza industry the process of fermentational development is typically referred to as “proofing.” Accordingly, a dough ball that is fermentationally under-developed is referred to “under-proofed,” a dough ball that is fermentationally over-developed is referred to as “over-proofed,” and a dough ball that's at a level of optimal fermentational development is referred to as “optimally proofed.” Typically, pizza-makers determine whether a particular dough ball is at a level, or state, of optimal fermentational development by observing the volume, or size, of the dough ball. One popular indicator that's used for identifying the condition of optimal fermentational development is dough ball diameter (e.g., “when the dough ball reaches a diameter of such-and-such it's ready to use”).

A big challenge facing commissary-based pizza companies is that of getting all of its pizzas made with optimally proofed dough balls. However, that challenge is seldom if ever fully satisfied. Instead, a large percentage of pizzas are made with non-optimally-proofed dough balls. This occurs because recently-received dough balls (i.e., balls that have been in the store for only 24 to 48 hours) tend to be under-proofed.

In an attempt to correct this problem, some pizzeria enterprises (either single store or entire company) implement a warm-temperature proofing process. Warm-temperature proofing involves removing one or more trays of under-proofed dough balls from the refrigerator and stacking those trays in some non-refrigerated place, or “warm spot,” in the store. This, in effect, moves the dough balls from an approximately 35 degree Fahrenheit environment to an approximately 75 degree Fahrenheit environment. As a result, the store's dough ball inventory embodies a diversified proofing-mix composition involving dough balls disposed in various states, or levels, of proofing development.

Of course, as the temperature of a dough ball changes from 35 degrees F. to 75 degrees F., the rate of proofing greatly accelerates. This accelerated rate of proofing enables pizza stores to bring under-proofed dough balls to a state of optimal proofing within a matter of hours as opposed to days.

However, warm-temperature proofing as it's currently applied does not result in 100 percent optimally proofed dough balls. In order for the warm-temperature proofing process to yield optimally proofed dough balls by the time that the dough balls are made into pizzas, the dough balls must be removed from the refrigerator at just the right time. If they're removed from the refrigerator too late they'll still be under-proofed by the time that they're made into pizzas. Conversely, if they're removed from the refrigerator too early they'll be over-proofed by the time that they're made into pizzas.

The period of time that it takes for an under-proofed dough ball to reach a state of optimal proof at warm-air, or room, temperature can be referred to as the dough ball's “warm-temperature proofing time.” One of the major factors contributing to a pizza company's inability to achieve 100 percent optimally proofed dough balls from warm-temperature proofing is the fact that dough balls in different points of fermentational development require different lengths of warm-temperature proofing time. Specifically, a dough ball that's greatly under-proofed (i.e., a “young” dough ball) requires a substantially longer warm-temperature proofing time than does a dough ball that's only slightly under-proofed (i.e., a “middle-age” dough ball). Unfortunately, a pizza store manager has no way of calculating the warm-temperature proofing time of the various ages, or levels of fermentational development, of the dough balls in his refrigerator on any given day. So the warm-temperature proofing process is basically hit-and-miss, which means that many pizzas are still being made with non-optimally-proofed dough balls.

In a nutshell, the challenge that pizza companies face with the warm-temperature proofing process is one of proper timing—that is, knowing at what TIME to remove a particular quantity of dough balls of a particular point of proofing development from the refrigerator in order to get those balls to proof to a state of optimal proofing development by the time that they're needed for making into pizzas.

In addition to fresh dough, within the pizza industry there are companies that use frozen dough balls and also frozen “rounds,” or circular sheets, of dough. Some of these companies use computer-based projection programs that utilize sales projection numbers to specify a number of frozen dough balls or dough rounds to be removed from a freezer and placed into a refrigerated environment for thawing and proofing in anticipation of projected future sales. However, these programs are inapplicable to the dough ball proofing process and, as a result, do not provide a way to achieve optimal timing of the warm-temperature proofing process as applied to refrigerated dough balls at various points of proofing development. Further, these companies are not managing a dough ball inventory that embodies a diversified proofing-mix composition, or multiple groups of dough balls disposed in various levels of proofing development.

So, there has remained a problem of how to manage the rate of proofing of an inventory of refrigerated pizza dough balls of diversified proofing-mix composition so that near-100 percent of pizzas are made with optimally proofed dough balls. This problem has not been solved by the prior art but is solved by our invention. By solving this problem, a pizza company can achieve enhanced pizza quality, customer satisfaction, and repeat sales.

In conclusion, it would be highly desirable to provide a method and system for enabling a pizza company to manage its dough ball proofing process in a way that increases its percentage of pizzas made from optimally proofed dough balls.

### SUMMARY OF THE INVENTION

Our invention is a method and associated system for creating and controlling an optimal rate of proofing of a plurality of non-frozen pizza dough balls by the application of a computer-based dough ball management algorithm.

More specifically, the invention involves a method for identifying a particular point in time when moving a particular quantity of a particular group of non-frozen pizza dough balls from a refrigerated environment to a warm-air environment will result in those dough balls reaching a state of optimal proofing development by the time that they're needed for making into pizzas. The essence of the method involves the following four steps:

(1) Providing a computer-based dough ball management algorithm incorporating a dough ball proofing-progression measurement system. That system specifies multiple points of dough ball proofing development including a target point and at least one sub-target point. The algorithm typically accommodates at least one warm-temperature proofing-time factor and a plurality of variables including at least one dough ball usage projection variable and at least one dough ball proofing-point inventory variable.

(2) Transmitting into the algorithm a plurality of numerical values including at least one numerical value representing a dough ball usage projection value and at least one numerical value representing a dough ball proofing-point inventory value.

(3) Receiving computer-generated dough ball management information derived from the dough ball management algorithm. That information typically indicates an optimal time for moving a particular quantity of dough balls of a particular sub-target point of dough ball proofing development from the refrigerated environment to the warm-air environment.

(4) Based on the information received in step 3, moving a particular quantity of dough balls of a particular sub-target point of proofing development from the refrigerated environment to the warm-air environment at a point in time that will result in the dough balls reaching a level of optimal proofing development by the time that they're needed for making into pizzas.

Additional steps may be included in the method; however, the above four steps constitute the essence of the method.

A particular system is associated with the method. That system typically comprises a refrigerated inventory of dough balls disposed in at least one sub-target point of proofing development, a pizzeria worker, a computer system (or computer network), and a particular dough ball management algorithm residing in the computer system. The dough ball management algorithm incorporates a dough ball proofing-progression measurement system involving multiple points of dough ball proofing development including a target point and at least one sub-target point. At an appropriate time the dough ball management algorithm provides a pizzeria worker with dough ball management information indicating a particular point in time when a particular quantity of pizza dough balls should be moved from the refrigerated inventory to a warm-air environment.

This system can be alternately conceptualized as three elements working in combination within a pizzeria enterprise, the three elements being (1) an inventory of non-frozen pizza dough balls disposed in a particular diversified proofing-mix composition (i.e., in multiple points, or stages, of dough ball proofing development), (2) a worker, and (3) a particular computer-based dough ball management algorithm. In this interacting combination, the dough ball management algorithm outputs dough ball management information that causes the worker to modify the proofing-mix composition of the inventory of pizza dough balls by moving a prescribed quantity of pizza dough balls at a prescribed point in time from a refrigerated proofing environment to a warm-temperature proofing environment.

A complete understanding of the invention can be obtained from the detailed description that follows.

### OBJECT AND ADVANTAGES

The object of our invention is optimal control of the proofing cycles of a plurality of pizza dough balls disposed in a diversified proofing-mix composition, the purpose of which is to get the dough balls proof to a level of optimal proofing development by the time that they're needed for making into pizzas.

The advantages of our invention are (a) achievement of a higher percentage of pizzas made with optimally-proofed dough balls, which leads to (b) enhanced pizza quality, which leads to (c) greater pizza-eater satisfaction, which leads to (d) increased repeat sales, which leads to (e) increased profit for a pizza company.

Further objects and advantages of the invention will become apparent from consideration of the following detailed description, related drawings, and appended claims.

### BRIEF DESCRIPTION OF THE DRAWINGS

FIG. 1 is a computer spreadsheet used for illustrating basic relationships in an example dough ball management algorithm.

FIG. 2 is a graph illustrating the dough ball removal schedule shown in FIG. 1.

FIG. 3 is the computer spreadsheet of FIG. 1 with different dough ball proofing-point inventory values.

FIG. 4 is a graph illustrating the dough ball removal schedule shown in FIG. 3.

FIG. 5 is the computer spreadsheet of FIG. 1 with different dough ball usage projection values.

FIG. 6 is a graph illustrating the dough ball removal schedule shown in FIG. 5.

### DESCRIPTION OF THE PREFERRED EMBODIMENT OF THE METHOD

Our invention involves a method and system whereby a pizza company that makes pizzas from dough balls can identify the optimal times when certain quantities of those dough balls should be moved from a refrigerated environment to a warm-air environment for the purpose of causing the dough balls to rise, or proof, to an optimal level of proofing development by the time that those dough balls are needed for making into pizzas. This section discusses the method. A subsequent section takes up the system.

As the terms are used herein, a “refrigerated environment” is an environment having an ambient temperature averaging less than 50 degrees Fahrenheit (10 degrees C.), and a “warm-air environment” is an environment having an ambient temperature averaging between 50 to 140 degrees Fahrenheit (10 to 60 degrees C.).

In summary form, the presently preferred embodiment of the method comprises the following four basic steps:

(1) providing a computer-based dough ball management algorithm incorporating a dough ball proofing-progression measurement system;

(2) periodically transmitting into the algorithm one or more dough ball usage values and one or more dough ball proofing-point inventory values;

(3) periodically receiving computer-generated dough ball management information from the algorithm specifying optimal times for moving particular quantities of dough balls of various points of proofing development from a refrigerated environment to a warm-air environment; and

(4) based on the information received in step 3, moving a particular quantity of dough balls of a particular sub-target point of proofing development from the refrigerated environment to the warm-air environment at a point in time that will result in the dough balls reaching the target point of proofing development by the time that they're needed for making into pizzas.

Following, now, is a detailed description of these steps.

STEP 1: Provide a computer-based dough ball management algorithm incorporating a dough ball proofing-progression measurement system involving multiple points of dough ball proofing development including a target point and at least one sub-target point, with the algorithm accommodating at least one warm-temperature proofing-time factor and a plurality of variables comprising (a) at least one dough ball usage projection variable and (b) at least one dough ball proofing-point inventory variable.

As the term is used herein, a “dough ball management algorithm” is an algorithm that can be used for managing the rate of proofing of pizza dough balls. It may be that such an algorithm can be provided by a company that sells point-of-sale (P.O.S.) software. However, if an appropriate dough ball management algorithm does not exist or cannot be obtained, one must be devised. In this case the devising process would constitute an additional step in the method.

In the instant invention the algorithm incorporates a dough ball proofing-progression measurement system. If an appropriate dough ball proofing-progression measurement system does not exist or cannot be obtained, one must be devised for use in the algorithm. In this case the devising process would constitute an additional step in the method. To facilitate communication and subsequent use, the proofing-progression measurement system should be represented in written or diagrammatic form, although this is not a requirement for application of the method.

As the term is used herein, a “dough ball proofing-progression measurement system” is a conceptual construct that identifies at least two points in the proofing cycle of a particular type of dough ball by associating with each of the points a numerical value associated with an applicable proofing-criterion format. Any form of measurement, or measurement system, that can be used for ascertaining the amount of proofing that a particular dough ball has undergone up to a given point in time qualifies as an “applicable proofing-criterion format.” (Examples of proofing-criterion formats are provided subsequently.)

The term “amount of proofing” refers to the amount of fermentational development that a particular dough ball has undergone due to the metabolic activity of the yeast in the dough. So, amount of proofing equates to amount of metabolic activity of the yeast in a given dough ball up to a given point in time. Finally, it is to be understood that a “numerical value” can be represented by either a single number or a range of numbers. Therefore, a “point” in the proofing cycle of a dough ball can be represented by either a single number or a numerical range. Accordingly, where the term “value” is recited in the appended claims, it encompasses both a single number and a numerical range. When a numerical range is used for defining a point in the proofing cycle, that point could be accurately termed a “stage” in the proofing cycle, if so desired.

The number of possible points of proofing development within a proofing-progression measurement system can range from two to conceivably hundreds. When a relatively low number of points is delineated within the proofing-progression measurement system, the numerical value associated with each point would most likely be a numerical range. When a relatively high number of points is delineated within the system, the numerical value associated with each point could possibly be a single number.

The optimal number of points for a particular pizza company depends on a number of factors including dough formula and operating system of the pizza company. For starters, we suggest that either four or five points of proofing development be incorporated within the dough ball proofing-progression measurement system. However, subsequent testing and operation of the method may suggest a different optimal number of points for a particular pizzeria operation.

In devising the proofing-progression measurement system, one of the points is designated as the target point. We define “target point” as that point in proofing development which the pizza company wants a particular type of dough ball to be in at the point in time that it's made into a pizza. Accordingly, the target point could logically be referred to as the point of optimal proofing development. Typically this is the point that is deemed by the pizza company as being ideal for producing a pizza crust of optimal eating characteristics.

In addition to the target point there are one or more other points in the proofing-progression measurement system. At least one, and probably three or four, of these points precedes the target point in the proofing cycle of a dough ball. Or, in other words, as a dough ball progresses through the proofing cycle it travels through these other points prior to reaching the target point. These other points are designated as sub-target points. So, we define “sub-target point” as a point in the proofing cycle, or proofing period, of a dough ball that precedes the target point. Accordingly, a sub-target point could logically be referred to as a point of sub-optimal proofing development.

The recommended proofing-criterion format for this preferred embodiment is dough ball diameter (as measured from top view). To illustrate how it might work we use a fictitious example. Assume that the dough ball proofing-progression measurement system for a given type of dough ball involves four points of proofing development: a target point and three sub-target points arbitrarily labeled point 1, point 2, and point 3 (or first point, second point, third point). To measurably define the various points we ascribe a length range that the diameter of a dough ball will exhibit when in each particular point. So, when written out, a fictitious dough ball proofing-progression measurement system could be thus:

Point 1=Dough ball diameter under 4.99 inches

Point 2=Dough ball diameter 5.0 to 5.49 inches

Point 3=Dough ball diameter 5.5 to 5.99 inches

Target point=Dough ball diameter 6.0 to 6.5 inches

To use a diameter-based system for ascertaining the proofing point of any particular dough ball, a person could simply position a ruler across a dough ball and measure its diameter. If, for example, the dough ball measured 5.3 inches in diameter, it would be classified as being in point 2 in the above example.

Any device that can be used for ascertaining the level of proofing development of a given dough ball we call a “proofing-level measuring device.” We note here that it's possible to use a custom-designed measuring device in place of an ordinary ruler for measuring dough ball diameter. For example, this device could be a ruler-like tool comprising two parts: a horizontal part containing a measuring scale for measuring the dough ball's diameter and a vertical part disposed perpendicular to the horizontal part and appending downward. When measuring a dough ball the vertical part would be butted against a side edge of the dough ball. This would assure that the “beginning end” of the measuring scale is positioned directly above a side edge of the dough ball, thereby assuring an accurate diameter measurement and also speeding the measuring process. Additionally, the measuring scale need not necessarily be in a conventional format. For example, it could be adapted to represent the points, or numerical ranges, of the dough ball proofing-progression measurement system, wherein the length range of each particular point is indicated by a particular color or marking, thereby eliminating the need for a person to have to take the time to translate a numerical number into a particular proofing point category.

If the actual values, or “numbers,” associated with the various proofing points of a proofing-progression measurement system are unknown, one must conduct proofing-progression testing. In this case the testing process would constitute an additional step in the method. Proofing-progression testing involves monitoring the proofing cycle of one or more dough balls of a particular type of dough ball for the purpose of ascertaining a particular value, or range of values, for each of the proofing points specified in a particular dough ball proofing-progression measurement system.

The process of proofing-progression testing is straight-forward. In simplistic summary form, it's as follows. Subject the test dough ball(s) to the standard proofing period and conditions—that is, to the proofing period and conditions that dough balls are exposed to during typical day-to-day operations in the commissary and pizzeria. As the dough balls progress through the proofing period (also sometimes called proofing cycle) observe their proofing development and at various levels of development take a “reading” using the chosen proofing-criterion format (e.g., dough ball diameter). Record the readings as they relate to the various levels of proofing development. Finally, assign a value (single number or, most likely, a range) to each of the points defined in the dough ball proofing-progression measurement system. If it happens that the testing is conducted prior to formulating the system, use the test data as a basis for determining the optimal number of points that the system should contain.

As specifically applied to the proofing-criterion format of dough ball diameter, during the testing a person would periodically measure the diameter of one or more test dough balls as those balls proceed through the proofing cycle. From that information the person would determine a numerical range of diameter lengths that applies to each proofing point delineated in the proofing-progression measurement system.

In addition to the proofing-progression measurement system, the preferred embodiment of the dough ball management algorithm accommodates (a) a warm-temperature proofing-time factor for each of the proofing points, (b) a dough ball usage projection variable for each of the pizza-making periods throughout a working day (a “pizza-making period” being a certain increment of time in which pizza-making takes place), and (c) a dough ball proofing-point inventory variable for each of the proofing points defined in the system.

The warm-temperature proofing-time factor would typically be a relatively fixed factor that remains the same from day to day (but could change from season to season or with dramatic changes in store ambient temperature). Therefore, values for this factor typically would be installed into the dough ball management algorithm at installation, or set-up time. So we will discuss it in the following paragraph. However, values for the dough ball usage projection variables and proofing-point inventory variables would likely change from day to day. Accordingly, discussion of these occurs in Step 2.

In setting up the dough ball management algorithm to do its job, a warm-temperature proofing-time value for each of the various sub-target points of each particular type of dough ball is transmitted into the algorithm. As the term is used herein, a “warm-temperature proofing-time value” is the length of time that it takes a dough ball in a particular sub-target point to proof to the target point when that dough ball is held in a particular warm-air environment. A “particular” warm-air environment would be an environment that maintains a particular average temperature within the range of 50 to 140 degrees Fahrenheit. In a typical pizzeria, the warm-air environment would be the pizza store, which is usually around 75 degrees F. However, it's possible to have a warm-air environment of higher or lower temperature than the pizza store. For example, a proofing cabinet could be used to create a warm-air environment that's of higher temperature than that of the pizza store.

If the warm-temperature proofing-time value of each sub-target point of a particular type of dough ball is not known, one must conduct warm-air proofing-progression testing. In this case the testing process would be considered to be an additional step of the method. To conduct warm-air proofing-progression testing, a test dough ball, or more likely a tray or multiple trays of test dough balls, of a particular sub-target point is moved from the standard refrigerated proofing environment to a particular warm-air environment. Then the length of time that it takes for those dough balls to reach the target point of proofing development is observed and notated. This length of time becomes the warm-temperature proofing-time value associated with that particular sub-target point of that particular type of dough ball. This process is conducted for all the sub-target points of all the types of dough balls used by a pizzeria. The result is a set of warm-temperature proofing-time values associated with all the sub-target points of all the types of dough balls. These values are then entered, or transmitted, into the algorithm.

In some pizzerias the ambient air temperature fluctuates substantially from season to season. A substantial change in ambient temperature can result in a change in warm-temperature proofing times. If this occurs, warm-temperature proofing times may need to be periodically re-transmitted to, or updated within, the algorithm.

STEP 2: Transmit into the algorithm (a) dough ball usage projection values for the various pizza-making periods of a given day and (b) dough ball proofing-point inventory values as of a certain time for each of the various types of dough balls in the proofing cycle.

Detailed explanation of this step follows.

To begin, it will be appreciated that information can be transmitted into the dough ball management algorithm by any of various means. For example, it can be entered through a keyboard. It can also be entered through a touch-screen. It can be transmitted by direct linking of one device to another. And it can be transmitted by another program or algorithm in the computer system providing information to this algorithm. All these means, along with any other information-transmission means not described herein, are considered to constitute various possible ways of “transmitting” information into the dough ball management algorithm. Now we discuss the various types of information to be transmitted.

A first type of information that's transmitted to the dough ball management algorithm is dough ball usage projection values for various pizza-making periods of a given day. For a typical pizzeria operation, pizza-making periods consist of one-hour increments such as 1 to 2 p.m., 2 to 3 p.m., 3 to 4 p.m., and so forth. (However, the length of pizza-making periods could be something other than 1-hour increments and, if this existed, it would be considered to fall within the scope of the instant invention.) A “dough ball usage projection value” is a number representing a quantity of a particular type of dough ball that's projected to be used during a particular pizza-making period. Typically this number would relate to a number, or “count,” of dough balls that's projected to be used during the period. However, it's possible for the number to represent a dollar sales volume figure instead of a dough ball count. When this is the case, the algorithm is constructed to convert the sales volume number into a dough ball count number.

These values can be transmitted into the algorithm through keyboard entry conducted by a person. However, they can also be electronically transmitted from a point-of-sale program to the algorithm. In this case, the point-of-sale program would likely derive the dough ball usage projection values. Typically these values would be transmitted to the algorithm on a daily basis. However, it's possible to do it based on other periods of time and, if done, would fall within the scope of the invention.

The second type of information that's transmitted to the dough ball management algorithm is dough ball proofing-point inventory values. A “dough ball proofing-point inventory value” is a number representing the quantity of a particular type of dough ball of a particular point of proofing development that's disposed within a dough ball inventory of a pizzeria. These inventory numbers could be derived from taking a physical inventory or could be derived from a perpetual inventory system. Either way is regarded as falling within the scope of the instant invention. If the numbers are derived by conducting a physical inventory (also called a dough ball proofing-point inventory), it's recommended that the inventory be taken and the numbers transmitted into the algorithm prior to when the store opens for business on each day. However, with a perpetual inventory system it's possible to transmit the numbers once a week, for example, or when a shipment of new dough balls is received and put into the store inventory.

As applied to dough ball diameter, in order to ascertain the dough ball proofing-point inventory value for the target point and each sub-target point a person must measure the diameter of dough balls in refrigerated inventory. In doing this, a person is identifying the point of proofing development through dough ball measurement. However, that person usually needs to only measure a few representative balls in each group as all balls in a particular group typically undergo the same rate of proofing and, therefore, will have the same diameter. Conducting a physical inventory to ascertain dough ball proofing-point inventory values usually only need be done once a day, usually just before opening. If a dough ball proofing-point inventory is required to ascertain proofing-point inventory values, then it is regarded as a step in the method.

After this proofing-point inventory information is ascertained, it is transmitted into the dough ball management algorithm.

From the time that the proofing-point inventory of the refrigerated dough balls is conducted the balls continue to slowly proof. It is assumed herein that the rate of proofing is slow enough that the dough balls remain in the same proofing point throughout the day, or throughout the subsequent eight hours after the inventory is taken.

If, however, the dough balls progress from one point of proofing development to a subsequent point within this time period, it could be necessary for the dough ball management algorithm to include an inventory aging calculation mechanism. We define “inventory aging calculation mechanism” as a schedule or algorithm designed to indicate or compute the proofing point of a particular group of refrigerated pizza dough balls at a given point in time.

If a schedule is used for indicating the proofing point, the schedule essentially would constitute a computer-based chart associating a particular proofing point with a particular elapsed proofing time of a dough ball. To make this work, an elapsed proofing time would have to be calculated and transmitted into the dough ball management algorithm (a subsequent section on Alternate Proofing-criterion Formats further discusses elapsed proofing time). For this approach to work it's necessary that all batches of dough balls be subjected to the same temperature cycle throughout the proofing period. Elapsed proofing time would typically be depicted in hourly increments, and the proofing points associated with the increments would be ascertained by proofing-progression testing.

If an algorithm is used for calculating the proofing point, three categories of factors must be included in the algorithm: (1) dough ball proofing-point inventory values (described above), (2) the time gap between the current time and the time that the proofing-point inventory was taken, and (3) a refrigerated proofing rate, which would be the rate of proofing that a particular type of dough ball undergoes while in refrigerated inventory, or while held at a particular refrigerated temperature. (Note: the proofing rate could vary depending on the proofing point, or stage, of a particular dough ball. So testing likely would be required to determine the particular proofing rate for each proofing point.)

In conclusion, we do not foresee, for a typical pizza company, the need to include an inventory aging calculation mechanism within the dough ball management algorithm. Hence, it is not included within the preferred embodiment of the method. However, if an inventory aging calculation mechanism were required it would be considered as falling within the scope of the instant invention and appended claims.

STEP 3: From the dough ball management algorithm, receive dough ball management information that specifies an optimal time for moving a particular quantity of dough balls of a particular sub-target point of dough ball proofing development from a refrigerated environment (e.g., refrigerator) to a warm-air environment (e.g., ambient air of the pizzeria).

To remind or notify pizzeria staff of the right time to remove dough balls from the refrigerator, either the dough ball management algorithm or the point-of-sale program can provide a signal—which we refer to as a “real-time alerting signal”—to tell the staff that now is the time to move a particular quantity of dough balls from the refrigerator. The signal could be any form of alert, such as, for example, a sound emitted from a speaker or a flashing icon on a computer screen.

STEP 4: Based on the information received in step 3, move a particular quantity of dough balls of a particular sub-target point of proofing development from the refrigerated environment to the warm-air environment at a point in time that will result in the dough balls reaching the target point of proofing development by the time that they're needed for making into pizzas.

Once the dough balls are transferred from the refrigerator to the warm-air environment, they proceed through a warm-temperature proofing process for a particular length of time. This results in the dough balls proofing to the target point of proofing development by the time that they're needed for making into pizzas.

### A Sample Dough Ball Management Algorithm

The exact programming code and mathematical construction of a dough ball management algorithm depends on the values of the various factors and variables previously described. It also depends on the type of programming language that's used for writing the algorithm. However, for illustration purposes a basic sample algorithm will be provided. That sample algorithm is represented in a spreadsheet format (specifically a Microsoft Excel spreadsheet). The purpose of depicting it in a spreadsheet is to impart tangibility to the algorithm for explanation purposes—that is, to provide an intuitive visual representation of the interrelationships within the type of algorithm used in the instant invention.

It should be appreciated, however, that the algorithm would typically not reside in a spreadsheet format but, instead, would reside in a programming language more fitting to creating algorithms of this nature. It also should be appreciated that a dough ball management algorithm written in another computer programming language for use in a particular pizza company would likely be of a different construction and arrangement than the example algorithm depicted herein.

A competent computer programmer working in conjunction with a knowledgeable dough technologist—both of whom jointly understand the concepts and information discussed herein—can readily create a dough ball management algorithm designed to fit the particular operating system of a particular pizza company. In addition, a company that sells sophisticated point-of-sale (P.O.S.) software would likely be capable of creating such an algorithm and could be retained for that purpose. An example of such a company is Foodtec Solutions, Inc.

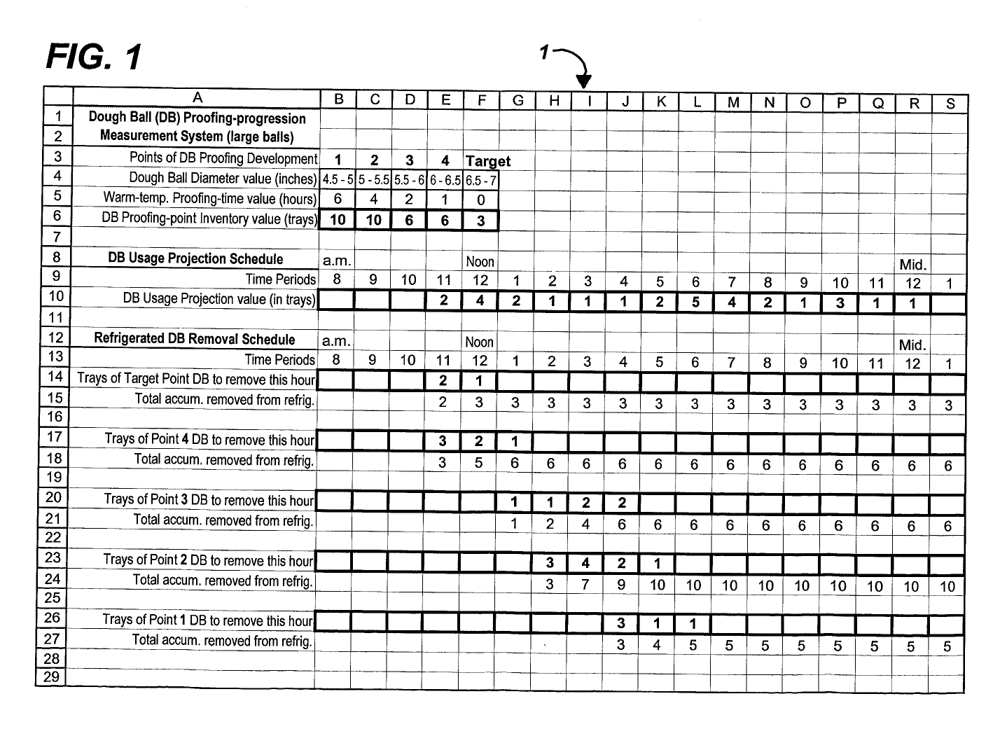

Referring now to the figures, FIG. 1 shows a spreadsheet 1 which contains a sample dough ball management algorithm. This algorithm is provided for illustrative purposes and is not intended to be a complete model or the only possible representation of dough ball management algorithm. In explaining the algorithm, references to particular cells within the spreadsheet will be made. To refer to a cell we specify its “address” within the spreadsheet. A cell address is defined by column letter and row number (column letters being along the top of the spreadsheet and row numbers being down the left side.) For example, the cell address B6 refers to the cell at the intersection of column B and row 6.

In addition, references to groups of contiguous cells will be made. Such references can involve cells in a row, cells in a column, or cells in a rectangular area. In referring to a group of cells we use a notation containing the first and last cells in the group with a colon between. For example, the notation B6:F6 refers to the group of cells B6, C6, D6, E6, and F6. Finally, when referring to a group of cells within a rectangular area, the first cell in the notation designates the upper left cell of the rectangle and the second cell in the notation designates the lower right cell. For example, the notation B5:D6 refers to the rectangle of cells consisting of B5, B6, C5, C6, D5, and D6.

Now we begin. The dough ball management algorithm depicted by spreadsheet 1 includes a dough ball proofing-progression measurement system depicted in area A1:F4. (Throughout the spreadsheet the abbreviation DB is used for Dough Ball.) This proofing-progression measurement system is for a particular type of dough ball which, for purposes of the illustration, we've defined as a “large ball.” The proofing-progression measurement system arbitrarily consists of five points of dough ball proofing development arbitrarily labeled 1, 2, 3, 4, and Target, as indicated in B3:F3. The point labeled “target” is the target point in the proofing development cycle and the other four points are sub-target points.

For a proofing-criterion format the algorithm uses dough ball diameter, as indicated in A4. To each of the five points of proofing development a particular diameter length range has been assigned, as indicated in B4:F4. (These numbers were arbitrarily chosen for the illustration and, therefore, may or may not reflect actual diameters for the various proofing points of a large dough ball.)

Further, the algorithm contains warm-temperature proofing-time values for each of the points of proofing development, as indicated in B5:F5. As you recall, warm-temperature proofing time is the length of time that it takes for a particular refrigerated dough ball at a particular sub-target point of proofing development to reach the target point when that dough ball is moved to a location of a particular warm (e.g., room) temperature. So, in our illustration, Point 1 has a warm-temperature proofing time of 6 hours, Point 2 has one of 4 hours, Point 3 has one of 2 hours, Point 4 has one of 1 hour, and the Target Point has no warm-temperature proofing time. The warm-temperature proofing time for the target point is typically zero because that stage is presumed to already be at the point of optimal fermentational development and, therefore, requires no more proofing. The warm-temp proofing-time numbers are arbitrarily-chosen values for illustration purposes. In actuality they would be derived from proofing-progression testing. These values would be entered into the algorithm during its initial set-up. However, they could be changed later on, if conditions required.

Cells B6:F6 contain dough ball proofing-point inventory values for each of the five points of proofing development. In our example algorithm these values define the number of trays of large dough balls held in inventory at the start of a given pizza-making day. Accordingly, the information indicates that at the start of the day used in this illustration there are 10 trays of large dough balls in the Point 1 stage of proofing development, 10 trays in the Point 2 stage, 6 trays in the Point 3 stage, 6 trays in the Point 4 stage, and 3 trays in the Target stage. Typically, these numbers would be transmitted into the algorithm on a daily basis, prior to store opening.

(Note: The preferred embodiment, and hence this sample algorithm, does not involve an inventory aging calculation mechanism for reasons previously explained. However, if such a calculation were included, it would result in calculating “updated” proofing-point values for each proofing point for each hour of the day. This, in turn, would result in the dough ball removal numbers for each hour being based on “hourly-updated” proofing-point values. To the extent that the updated values differ from the original, or starting, values, the hourly dough ball removal numbers would differ from those shown in this sample algorithm.)

Moving downward in the spreadsheet, there is a dough ball usage projection schedule shown in area A8:S10. The illustration assumes that the workday of this particular pizzeria is divided into hour increments, as indicated in B9:S9. These are referred to as “pizza-making periods.” For each of the periods there is a dough ball usage projection value, as shown in B10:S10. These numbers represent the number of trays of large dough balls that are projected to be used, or consumed, for making large pizzas within each of those pizza-making periods. Cells that contain no number mean that zero trays, or no dough ball usage, is projected for that period. These numbers could be transmitted to the algorithm by a person or by another computer program, such as a point-of-sale program residing in the computer system that holds the dough ball management algorithm (in fact, the algorithm could possibly be a component of the point-of-sale program).

Moving on, there is a refrigerated dough ball removal schedule shown in area A12:S27. This dough ball removal schedule indicates the number of trays of large dough balls of each point of proofing development that is required to be removed from the refrigerator (and into a warm-air environment) at each hour of the workday in order to have enough optimally proofed dough balls to meet the dough ball usage requirement of each pizza-making period. The determining factor for each of the numbers is a set of logic formulas that involve (a) the warm-temperature proofing-time values (B5:F5), (b) the dough ball proofing inventory values (B6:F6), and (c) the dough ball usage projection values (B10:S10). We will now describe the logic formulas used to derive the dough ball removal schedule. We will do it by disclosing the particular formulas underlying a set of sample cells—specifically, cells F14, E17, and J26.

Cell F14 indicates that one tray of Target Point dough balls should be removed from the refrigerator. These dough balls are intended for use in satisfying the dough ball usage projection indicated by cell F10 (the 12 noon to 1 p.m. period). The spreadsheet formula underlying cell F14 is: =IF(F6=0, 0, IF(E15=F6, 0, IF((F6−E15)>=F10, F10, F6−E15))).

This formula performs the following function. First it tests to see if the starting inventory is devoid of dough balls in the Target Point stage. The code for this test is F6=0. If the answer is true (i.e., no dough balls), the algorithm enters a “0” and stops the calculation for this cell. If the answer is false, it continues the calculation.

Second, the formula tests to see if the stock, or inventory, of Target Point dough balls has been used up from prior withdrawals from the refrigerator. The code for this test is E15=F6. If the answer is true, it enters a “0” and stops the calculation. If the answer is false, it continues.

Third, the formula tests to see if there's enough stock to fill the entire “order” called for by cell F10. The code for this test is (F6−E15)>=F10. If the answer is true, the algorithm fills the order with the instruction F10. If the answer is false, the algorithm fills what it can of the order by assigning all its remaining inventory to it, with the instruction F6−E15. It then becomes the “job” of the next stages (i.e., Point 4 and below) to fill that portion of the order that's left unfilled.

The formula underlying cells representing sub-target points is slightly more complex than the above formula. For illustration we use cell E17. This cell indicates that three trays of Point 4 large dough balls should be removed from the refrigerator at 11 a.m. These dough balls are intended for use in satisfying the dough ball usage projection indicated by cell F10 (the 12 noon to 1 p.m. period). The reason that cell E17 pertains to the usage projection given in cell F10 is because Point 4 dough balls require a one-hour warm-temperature proofing time (as indicated by cell E5) in order to reach the level of optimal proof. Accordingly, the spreadsheet formula underlying cell E17 is: =IF(E6=0, 0, IF(F10=F14, 0, IF(D18=E6, 0, IF((E6−D18)>=(F10−F14), F10−F14, E6−D18)))).

This formula performs the following function. First it tests to see if the starting inventory is devoid of dough balls in this stage. The code for this test is E6=0. If the answer is true (i.e., no dough balls), the algorithm enters a “0” and stops the calculation for this cell. If the answer is false, it continues the calculation.

Second, it tests to see if the usage projection, or “order,” has been filled by an older stage of dough (in this case, the Target Point stage). The code for this test is F10=F14. If the answer is true, the algorithm enters a “0” and stops the calculation. If the answer is false, it continues.

Third, it tests to see if the stock, or inventory, of Point 4 dough balls has been used up from prior withdrawals from the refrigerator. The code for this test is D18=E6. If the answer is true, it enters a “0” and stops the calculation. If the answer is false, it continues.

Fourth, it tests to see if there's enough stock to fill the entire “order” contained in cell F10 or at least enough to fill the remaining portion of the order that has not been filled by older stages of dough balls (in this case, Target Point dough balls). The code for this test is (E6−D18)>=(F10−F14). If the answer is true, the algorithm fills the remaining portion of the order with the instruction F10−F14. If the answer is false, the algorithm fills what it can of the order by assigning all of its remaining inventory to it, with the instruction E6−D18. It then becomes the “job” of the lower stages (i.e., Points 3, 2, and/or 1) to fill that portion of the order left unfilled by Point 4 dough balls.

The Point 1 level of dough ball requires the most complex formula; although it basically functions the same way as the above-described formula for a Point 4 dough ball. For illustration, provided below is the formula for cell J26. This cell indicates that three trays of Point 1 large dough balls should be removed from the refrigerator at 4 p.m. These dough balls are intended for use in satisfying the dough ball usage projection indicated by cell P10 (the 10 p.m. to 11 p.m. period). The reason that cell J26 pertains to the usage projection given in cell P10 is because Point 1 dough balls require a six-hour warm-temperature proofing time (as indicated by cell B5) in order to reach the level of optimal proof. Accordingly, the spreadsheet formula underlying cell J26 is: =IF(B6=0, 0, IF(P10=(P14+O17+N20+L23), 0, IF(I27=B6, 0, IF((B6−I27)>=(P10−P14−O17−N20−L23), P10−P14−O17−N20−L23, B6−I27)))).

This formula performs the following function. First it tests to see if the starting inventory is devoid of dough balls in this stage. The code for this test is B6=0. If the answer is true (i.e., no dough balls), the algorithm enters a “0” and stops the calculation for this cell. If the answer is false, it continues the calculation.

Second, it tests to see if the usage projection, or “order,” has been filled by an older stage of dough (in this case, the stages labeled Points 2 through 4 and Target Point). The code for this test is P10=(P14+O17+N20+L23). If the answer is true, the algorithm enters a “0” and stops the calculation. If the answer is false, it continues.

Third, it tests to see if the stock, or inventory, of Point 4 dough balls has been used up from prior withdrawals from the refrigerator. The code for this test is I27=B6. If the answer is true, it enters a “0” and stops the calculation. If the answer is false, it continues.

Fourth, it tests to see if there's enough stock to fill the entire “order” contained in cell P10 or at least enough to fill the remaining portion of the order that has not been filled by older stages of dough balls (in this case, Target Point and Points 2 through 4 dough balls). The code for this test is (B6−I27)>=(P10−P14−O17−N20−L23). If the answer is true, the algorithm fills the remaining portion of the order with the instruction P10−P14−O17−N20−L23. If the answer is false, the algorithm fills what it can of the order by assigning all of its remaining inventory to it, with the instruction B6−I27.

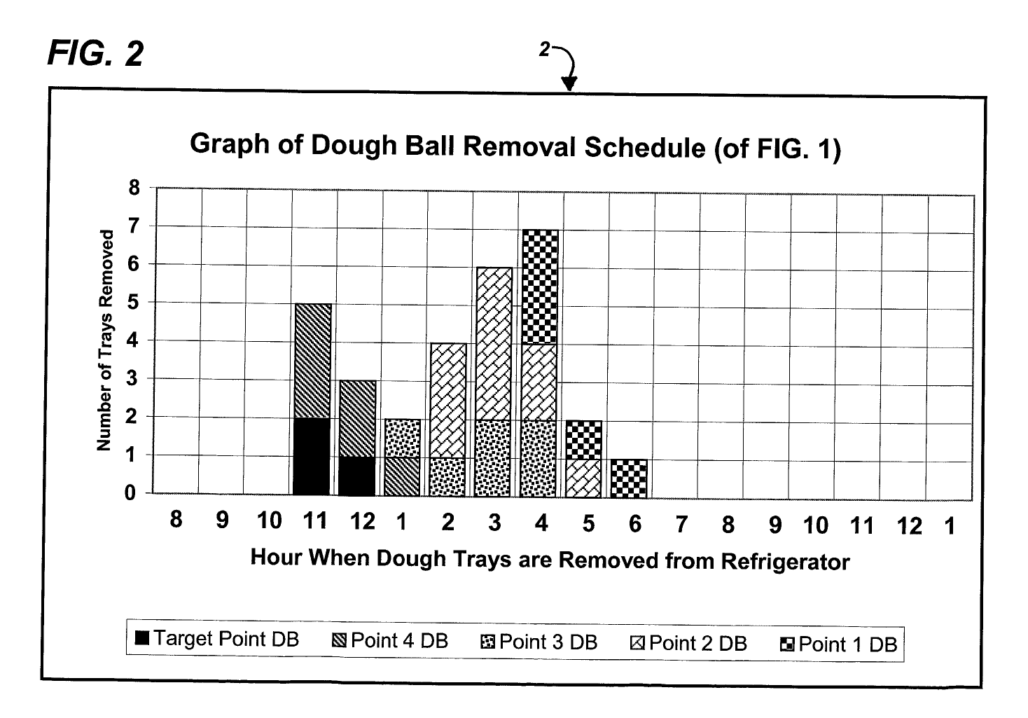

For illustration purposes, a graph 2 of FIG. 2 depicts the dough ball removal schedule shown in spreadsheet 1.

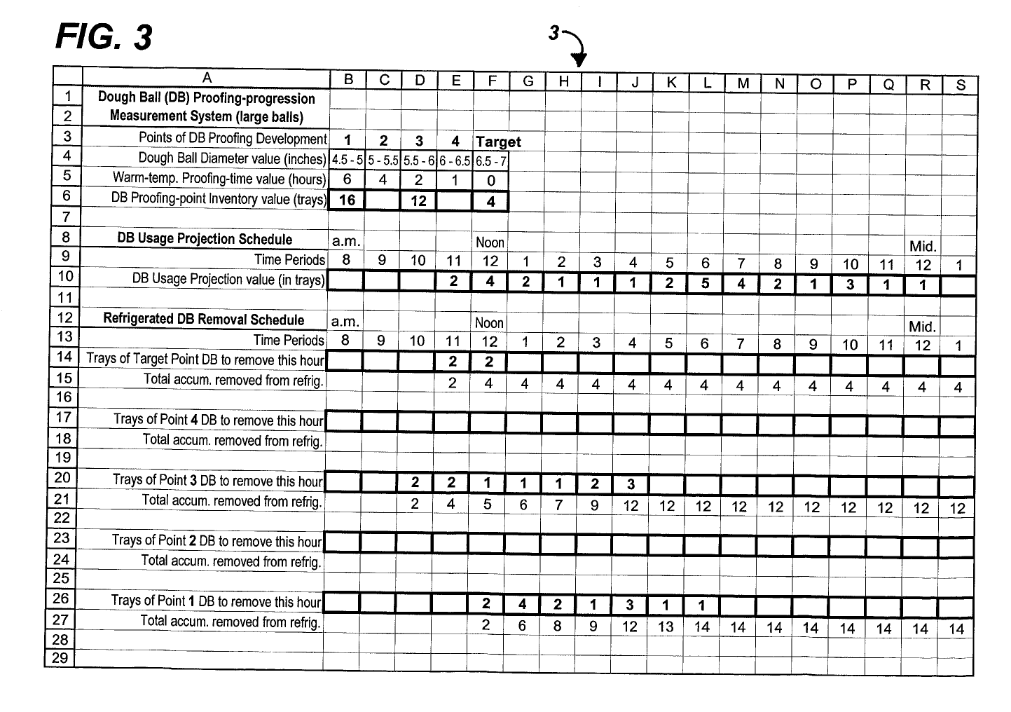

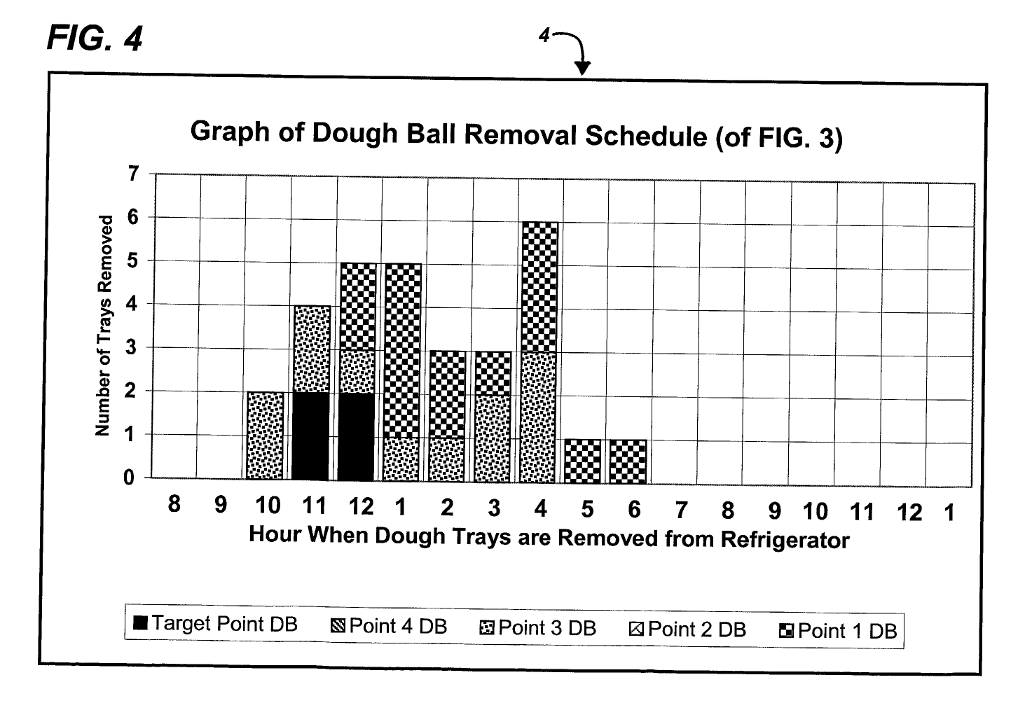

As previously explained, proofing-point inventory values (B6:F6) and dough ball usage projection values (B10:S10) are variables that change day to day. Accordingly, as these values change so do the values reflected in the dough ball removal schedule. To illustrate, we provide FIGS. 3-6. FIG. 3 shows a spreadsheet 3. Spreadsheet 3 is spreadsheet 1 with a different set of proofing-point inventory values (B6:F6). As can be seen, Points 2 and 4 contain no dough balls in inventory. FIG. 4 shows a graph 4 depicting the dough ball removal schedule of spreadsheet 3.

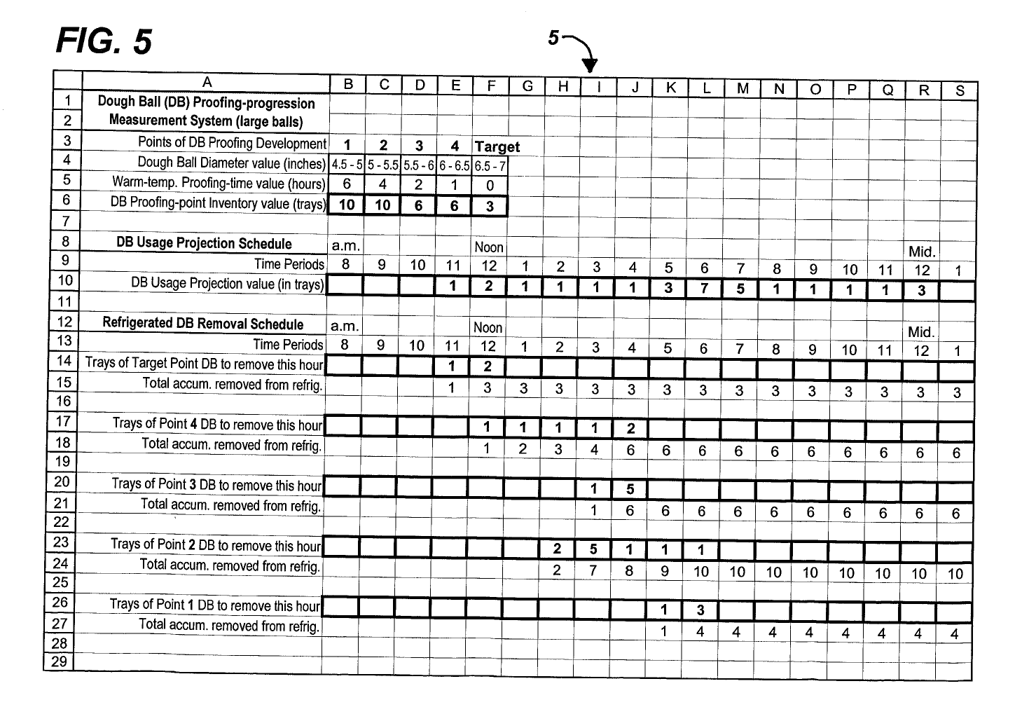

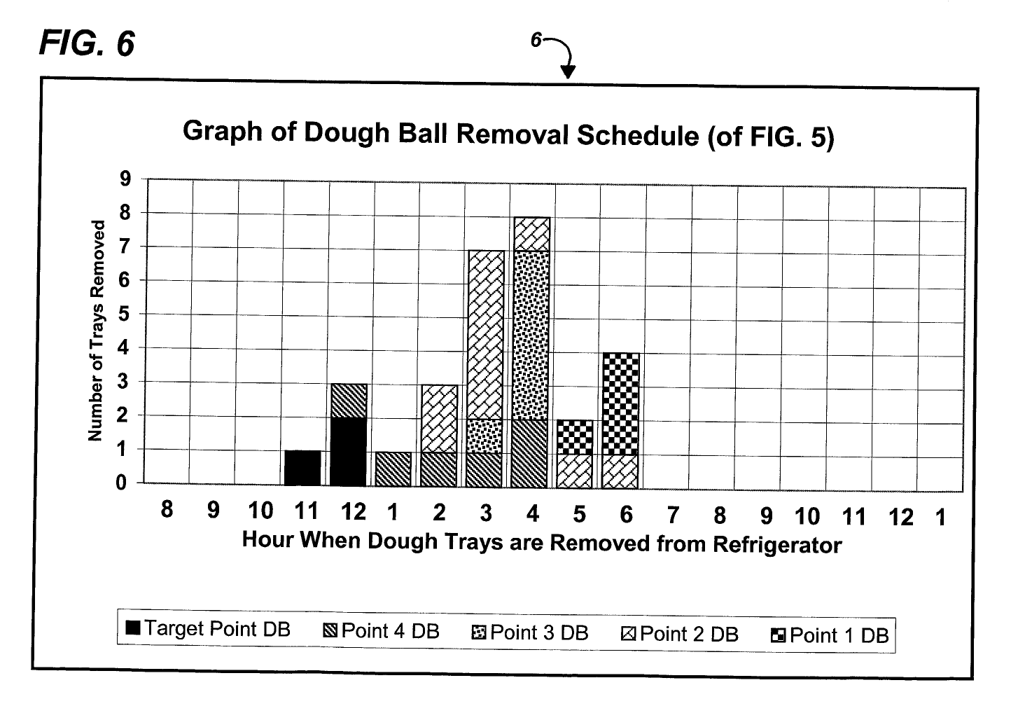

FIG. 5 shows a spreadsheet 5. Spreadsheet 5 is spreadsheet 1 with a different set of dough ball usage projection values (B10:S10). FIG. 6 shows a graph 6 depicting the dough ball removal schedule of spreadsheet 5.

As can be seen by comparing graphs 2, 4, and 6, a change in proofing-point inventory and dough ball usage projection values can make a substantial change in the corresponding dough ball removal schedule.

The above-described algorithm is a simplistic explanation. It is possible to construct a dough ball management algorithm in ways other than this and to include factors and variables not included above. If this were done the resulting algorithm would still be regarded as constituting an algorithm that falls within the scope of the instant invention and appended claims.

### Alternate Proofing-Criterion Formats

The recommended proofing-criterion format for the presently preferred embodiment is dough ball diameter. However, any form of measurement—or any measurement system or construct—that can be used for ascertaining the amount of proofing that a particular dough ball or group of dough balls has undergone up to a given point in time qualifies as an “applicable proofing-criterion format.” Therefore, if an alternative proofing-criterion format were used in the application of the instant invention, it would be regarded as falling within the scope of the invention and as being covered within the claims.

For illustration purposes an example of a possible alternate proofing-criterion format will now be provided. To describe it we must first provide a simplistic explanation of the dough ball proofing process.

After a dough ball is made, two primary factors determine the proofing point that the dough ball is in at any point in time. The first factor is the length of time that the dough ball has been disposed in the proofing cycle. We refer to this length of time as “elapsed proofing time.” The greater the elapsed proofing time, the greater the amount of proofing that the dough ball will accumulate, or undergo.

The second factor is the average temperature that the dough ball has sustained over the elapsed proofing time. The higher the average temperature (up to about 100 degrees F.), the greater the amount of proofing that the dough ball will accumulate.

This particular alternate proofing-criterion format is based on the first factor—elapsed proofing time. However, it's possible that a proofing-criterion format could also be conceived around the temperature factor and, if that were done, it would be regarded as falling within the scope of the invention and as being covered within the appended claims. Such a format could, for example, involve recordation of the temperature cycle that a particular dough ball, or group of dough balls, is exposed to as it progresses through the proofing cycle. This would likely involve a sophisticated electronic temperature measuring device that would accompany the dough ball(s) throughout the proofing period.

To effectively use the elapsed proofing time measurement format in a dough ball proofing-progression measurement system, all batches of dough balls (i.e., batches from two different days) must be subjected to the same temperature conditions, or same temperature cycle, over the duration of the dough balls' proofing period. If the temperature cycle varies substantially from batch to batch, then this criteria becomes undependable and is not recommended. However, assuming that the temperature cycle is relatively constant, elapsed proofing time might be effectively employed for identifying proofing points. This works because all dough balls of a same formula, or recipe, undergo the same rate of proofing at any given temperature. Accordingly, elapsed proofing time, or length of time that a dough ball is held in a particular proofing environment, can be used to define proofing points in a dough ball proofing-progression measurement system. To illustrate how it might work, we apply it to a dough ball proofing-progression measurement system having four points. When that's done, a fictitious example system could be thus. (For simplicity, the abbreviation EPT stands for elapsed proofing time.)

Point 1=Dough ball EPT less than 12 hours

Point 2=Dough ball EPT 12.0 to 17.9 hours

Point 3=Dough ball EPT 18 to 25.9 hours

Target point=Dough ball EPT 26 to 38 hours

To calculate elapsed proofing time a time-measuring means is associated with a particular dough ball or group of dough balls at a particular arbitrary “starting point” of the proofing period. One such time-measuring means could be as simple as a “proofing start-time label” affixed to a tray of dough balls, the label indicating the starting time of the proofing period, which might typically be the time that the dough balls were made. Another time-measuring means could be a mechanical or electronic “proofing timing device” placed in a tray of dough balls, the device indicating at any given time the total elapsed time since the start of the proofing period. It would not necessarily be required that a proofing timing device be placed in every tray. A batch, or “run,” of dough comprising multiple trays might need to have only one timing device placed into a tray representing the entire batch.

To ascertain the elapsed proofing time values as they relate to the target and sub-target points delineated in the proofing-progression measurement system, proofing-progression testing must be conducted. It basically would be the same as described for ascertaining dough ball diameter values, except that instead of measuring ball diameters a person would measure elapsed proofing time at various points in the proofing cycle and then use that information to assign a time range to the target point and to each sub-target point in the proofing cycle.

To determine dough ball proofing-point inventory values (i.e., the number of dough balls within each proofing point in inventory) when using the elapsed proofing time criterion, a person would refer to the time-measuring means—that is, the proofing start-time label, proofing timing device, or whatever—and, from the information provided by it, calculate the elapsed proofing time for each group of dough balls in the refrigerator. So, in doing this a person is identifying the point of proofing development through ascertaining elapsed proofing time.

### Description of the Preferred Embodiment of the System

As is apparent at this point, the above-described inventive method involves a system for controlling the rate of dough ball proofing in such a way that it results in having a correct number of optimally-proofed pizza dough balls at the time that those dough balls are needed for making into pizzas. The elements of that system have already been introduced and explained. Therefore, all that remains is to bring these elements together within a descriptive format that makes obvious the interrelationship of the system's components and, thereby, the nature and function of the system as a whole.

Accordingly, the presently preferred embodiment involves a dough ball management system comprising the elements of:

(1) a refrigerated inventory of non-frozen pizza dough balls disposed in at least one sub-target stage of dough ball proofing development;

(2) a computer system (or computer network); and

(3) a dough ball management algorithm residing in the computer system, wherein the dough ball management algorithm incorporates a dough ball proofing-progression measurement system involving multiple points of dough ball proofing development pertaining to the refrigerated inventory of pizza dough balls, including a target point and at least one sub-target point.

On a periodic basis throughout a day or week, the dough ball management algorithm provides dough ball management information that specifies when a particular quantity of dough balls in a particular sub-target point of proofing development should be moved from a refrigerated inventory to a warm-air environment. The desired end-result of the operation of the system is that it enables nearly all pizzas to be made with optimally-proofed dough balls.

In addition to the three elements described above, the system can further comprise the optional element of a dough ball proofing-level measuring device. A “dough ball proofing-level measuring device” is any device, or tool, that can be used for ascertaining the level of proofing development of a particular dough ball. An example of such a measuring device is a ruler used for measuring dough ball diameter.

This system can be alternately conceptualized as three interacting elements, the three elements being (1) an inventory of non-frozen pizza dough balls, (2) a worker, and (3) a computer-based dough ball management algorithm incorporating a dough ball proofing-progression measurement system. In this interacting combination the inventory of pizza dough balls is disposed in a particular diversified proofing-mix composition comprising dough balls disposed in multiple points of proofing development. These three elements interact in the following way. Periodically, the dough ball management algorithm outputs dough ball management information that causes the worker to modify the proofing-mix composition of the inventory of pizza dough balls by moving a prescribed quantity of pizza dough balls at a prescribed point in time from a refrigerated proofing environment to a warm-temperature proofing environment.

### Key Definitions

A number of new concepts and terms have been applied to describing the instant invention. To insure clarity of understanding, definitions of those concepts and terms are provided below.

“Dough ball management information” is information that can enable a person to manage the rate of proofing, or proofing cycle, of an inventory of pizza dough balls disposed in at least one sub-target point of proofing development.

The “proofing process” of a pizza dough ball refers to the process of the dough ball expanding from a small volume to a relatively large volume due to the gas released from the metabolic activity of the yeast within the dough ball. It is also referred to as “fermentational development.”

“Warm-temperature proofing” refers to dough balls proofing within a warm-temperature (50 to 140 degree F.) environment.

“Cold-temperature proofing”—also called refrigerated proofing—refers to dough balls proofing within a cold-temperature (sub-50 degree F.) environment.

“Warm-temperature proofing-time” is the length of time that it takes a refrigerated dough ball in a particular sub-target point of proofing development to proof to the target point when that dough ball is held in a particular warm-air environment.

A “warm-air environment” is an environment having an ambient temperature averaging between 50 to 140 degrees Fahrenheit (10 to 60 degrees C.).

A “refrigerated environment” is an environment having an ambient temperature averaging less than 50 degrees Fahrenheit (10 degrees C.).

A “dough ball management algorithm” is an algorithm that can be used for managing the rate of proofing of pizza dough balls.

A “dough ball proofing-progression measurement system” is a conceptual construct that identifies at least two points in the proofing cycle of a particular type of dough ball by associating with each of the points a numerical value associated with an applicable proofing-criterion format.

An applicable “proofing-criterion format” is any form of measurement, or measurement system, that can be used for ascertaining the amount of proofing that a particular dough ball has undergone up to a given point in time.

The term “amount of proofing” refers to the amount of fermentational development that a particular dough ball has undergone due to the metabolic activity of the yeast in the dough.

A “target point” is that point in proofing development which the pizza company wants a particular type of dough ball to be in at the point in time that it's made into a pizza.

A “sub-target point” is a point in the proofing cycle, or proofing period, of a dough ball that precedes the target point.

A “pizza-making period” is a certain increment of time in which pizza-making takes place.

A “dough ball usage projection value” is a number representing a projected quantity of a particular type of dough ball that's projected to be used during a particular pizza-making period.

A “dough ball proofing-point inventory value” is a number representing a quantity of a particular type of dough ball of a particular point of proofing development that's disposed within the dough ball inventory of a pizzeria.

“Conducting a dough ball proofing-point inventory” is the process of taking a physical inventory of a group of dough balls to ascertain the quantity of dough balls in each point of proofing development.

“Elapsed proofing time” is the length of time that a dough ball has been disposed in the proofing cycle.

“Proofing-progression testing” is the process of subjecting a given type of dough ball to the standard proofing period and proofing conditions that would exist for that type of dough ball in typical day-to-day operations and then ascertaining various values associated with each point of proofing development that the dough ball goes through during that proofing period. In addition to ascertaining proofing-point values, proofing-progression testing is also used for ascertaining warm-temperature proofing-time values. When used for this purpose it could be dubbed “warm-air proofing-progression testing.”

For a group of dough balls to have a “diversified proofing-mix composition” the group must comprise dough balls disposed in multiple points, or levels, of proofing development.

An “inventory aging calculation mechanism” is a computer-based schedule or algorithm designed to indicate or compute the proofing point of a particular group of refrigerated pizza dough balls at a given point in time.

### CONCLUSION, RAMIFICATIONS, AND SCOPE

We have disclosed a method and system whereby a pizza company that makes pizzas from dough balls can create an optimal rate of proofing for a plurality of dough balls of multiple points of proofing development.

In summary form, the presently preferred embodiment of the method comprises the steps of:

(1) providing a computer-based dough ball management algorithm incorporating a dough ball proofing-progression measurement system;

(2) periodically transmitting into the algorithm one or more dough ball usage values and one or more dough ball proofing-point inventory values;

(3) periodically receiving computer-generated dough ball management information from the algorithm indicating optimal times for moving particular quantities of dough balls of various points of proofing development from a refrigerated environment to a warm-air environment; and

(4) based on the information received in step 3, moving particular quantities of dough balls of particular sub-target points of proofing development from the refrigerated environment to the warm-air environment at points in time that result in the dough balls rising to an optimal point of proofing development by the time that they're needed for making into pizzas.

In addition, a system associated with the above method has been disclosed.

The disclosed components of the invention and arrangement thereof represent the preferred embodiments; however, other components and arrangements are possible within the scope of the invention.

For example, the foregoing description of the preferred embodiment implies that the warm-temperature proofing period should immediately precede the pizza-making period, or the point in time when the dough balls are made into pizzas. However, it's possible for the warm-temperature proofing period to be followed by a cold-temperature proofing period (i.e., a period in the refrigerator) prior to using the dough balls for pizza-making. If such were to occur it would be regarded as being within the scope of the instant invention and appended claims.

A key aspect of the invention involves the identification of multiple points of proofing development within a dough ball's proofing cycle. For ease of reference we have arbitrarily referred to those points with numbers (i.e., point 1, point 2, etc.). However, it is to be understood that any number assigned to proofing points in the claims (e.g., point 1, first proofing point) is for reference purposes only and is not to be construed as a reference to any particular level or degree of proofing development. Further, it is to be understood that an identification system other than numbers (e.g., letters) could be used and, if done, would fall within the scope of the invention.

In conclusion, it is understood that the invention is not to be limited to the disclosed embodiment but, on the contrary, is intended to cover various modifications and equivalent arrangements included within the spirit and scope of the appended claims, which scope is to be accorded the broadest interpretation so as to encompass all such modifications and equivalent structures as is permitted under the law.

We claim:

1. A method for identifying a particular point in time when moving a particular quantity of a particular group of non-frozen pizza dough balls from a refrigerated environment to a warm-air environment will result in said dough balls reaching a state of optimal proofing development by a predetermined future usage period when said dough balls will be made into pizzas, said method comprising the steps of:
providing a computer-based dough ball management algorithm incorporating a dough ball proofing-progression measurement system involving multiple points of dough ball proofing development including first and second points, said algorithm accommodating at least one warm-temperature proofing-time factor and a plurality of variables comprising (a) at least one dough ball usage projection variable and (b) at least one dough ball proofing-point inventory variable;
transmitting into said algorithm a plurality of numerical values including at least one numerical value representing a dough ball usage projection value and at least one numerical value representing a dough ball proofing-point inventory value;
receiving computer-generated dough ball management information derived from said dough ball management algorithm, said information indicating an optimal time for moving a particular quantity of dough balls disposed in said first point of dough ball proofing development from said refrigerated environment to said warm-air environment; and
based on said dough ball management information, moving said particular quantity of dough balls from said refrigerated environment to said warm-air environment at said optimal point in time, whereby said particular quantity of dough balls will proof to said second point of proofing development by a predetermined time.

2. The method of claim 1 further comprising the step of:
devising a dough ball proofing-progression measurement system capable of being used within a computer-based dough ball management algorithm.

3. The method of claim 1 further comprising the step of:
conducting proofing-progression testing of at least one type of dough ball and ascertaining a warm-temperature proofing time pertaining to said first point of dough ball proofing development.

4. The method of claim 1 further comprising the steps of:
devising a dough ball proofing-progression measurement system capable of being used within a computer-based dough ball management algorithm; and
conducting proofing-progression testing of at least one type of dough ball and ascertaining a warm-temperature proofing time pertaining to said first point of dough ball proofing development.

5. The method of claim 1 wherein:
said first point of proofing development is a sub-target point and said second point of proofing development is a target point.

6. The method of claim 1 wherein:
said at least one numerical value representing a dough ball usage projection value is derived within and transmitted from a computer-based point-of-sale program.

7. The method of claim 6 wherein during the receiving step:
at least one of said algorithm and said point-of-sale program provides a real-time alerting signal at said particular point in time when said particular quantity of dough balls should be moved from said refrigerated environment to said warm-air environment.

8. The method of claim 1 wherein:
said dough ball proofing-progression measurement system uses dough ball diameter as a proofing-criterion format.

9. The method of claim 8 further comprising the step of:
conducting proofing-progression testing of at least one type of dough ball and ascertaining a particular dough ball diameter value associated with said first point of dough ball proofing development.

10. The method of claim 8 further comprising the step of:
identifying a particular point of proofing development of said particular group of non-frozen pizza dough balls by measuring the diameter of at least one representative dough ball of this group of dough balls.

11. The method of claim 1 wherein:
said dough ball proofing-progression measurement system uses elapsed proofing time as a proofing-criterion format.

12. The method of claim 11 further comprising the step of:
conducting proofing-progression testing of at least one type of dough ball and ascertaining a particular elapsed proofing time defining said first point of dough ball proofing development.

13. The method of claim 11 further comprising the step of:
affixing a proofing start-time label to said particular group of non-frozen pizza dough balls.

14. The method of claim 11 further comprising the step of:
associating a proofing timing device with said particular group of non-frozen pizza dough balls, wherein output from said proofing timing device facilitates calculation of an elapsed proofing time of said particular group of non-frozen pizza dough balls.

15. The method of claim 11 further comprising the step of:
identifying a particular point of proofing development of said particular group of non-frozen pizza dough balls by ascertaining the elapsed proofing time of this group of dough balls.

16. The method of claim 1 wherein:
said dough ball proofing-progression measurement system incorporates a proofing-criterion format involving recordation of a temperature cycle over a proofing cycle of a particular dough ball.

17. The method of claim 1 wherein:
said multiple points of dough ball proofing development include first and second sub-target points.

18. The method of claim 17 further comprising the step of:
conducting a dough ball proofing-point inventory wherein several representative dough balls in said refrigerated environment are examined and the number of dough balls disposed in each of said first and second sub-target points is ascertained.

19. The method of claim 17 further comprising the steps of:
devising a dough ball proofing-progression measurement system capable of being used within a computer-based dough ball management algorithm;
conducting proofing-progression testing of at least two types of dough balls and ascertaining first and second warm-temperature proofing times respectively pertaining to said first and second sub-target points; and
conducting a dough ball proofing-point inventory wherein a plurality of representative dough balls in said refrigerated environment are examined and the number of dough balls disposed in each of said first and second sub-target points is ascertained.

20. The method of claim 1 wherein:
said dough ball management algorithm further incorporates an inventory aging calculation mechanism.

21. A system for assuring that a proper quantity of pizza dough balls of a particular type reaches an optimal level of proofing development by a particular pizza-making period when said quantity of dough balls is needed for making into pizzas, said system comprising:
a refrigerated inventory of pizza dough balls of said particular type, said dough balls being disposed in a sub-target point of dough ball proofing development;
a computer system; and
a dough ball management algorithm residing in said computer system, wherein said dough ball management algorithm incorporates a dough ball proofing-progression measurement system involving multiple points of dough ball proofing development including a target point and said sub-target point, said algorithm containing (a) a warm-temperature proofing-time value associated with said sub-target point of said particular type of pizza dough ball, (b) a dough ball usage projection value associated with said particular pizza-making period, and (c) a dough ball proofing-point inventory value associated with said refrigerated inventory of pizza dough balls, wherein at an appropriate time said dough ball management algorithm provides a pizzeria worker with dough ball management information specifying a numerical value for said proper quantity of pizza dough balls and indicating a particular point in time when said proper quantity of pizza dough balls should be moved from said refrigerated inventory to a warm-air environment, thereby enabling an optimal quantity of pizza dough balls to undergo warm-temperature proofing for a length of time that results in the dough balls reaching an optimal point of proofing development by a point in time that they're needed for making into pizzas.

22. The system of claim 21 wherein:
said dough ball management algorithm further incorporates an inventory aging calculation mechanism.

23. The system of claim 21 further comprising:
a dough ball proofing-level measuring device.

24. The system of claim 23 wherein:
said dough ball proofing-level measuring device is a ruler-type instrument adaptable to being used for measuring a diameter of a dough ball.

25. An interactive system for creating and controlling a particular variable rate of proofing of a particular plurality of non-frozen pizza dough balls, said system comprising:
a computer system;
a worker; and
a dough ball management algorithm residing in said computer system and incorporating a dough ball proofing-progression measurement system involving multiple points of dough ball proofing development;
wherein said dough ball management algorithm periodically outputs dough ball management information causing said worker to move a particular quantity of dough balls of a particular point of proofing development from one type of proofing environment to another type of proofing environment.

26. The interactive system of claim 25 wherein:
said dough ball management algorithm accommodates at least one warm-temperature proofing-time factor and a plurality of variables comprising (a) at least one dough ball usage projection variable and (b) at least one dough ball proofing-point inventory variable.

27. In combination, an inventory of non-frozen pizza dough balls, a worker, and a computer-based dough ball management algorithm incorporating a dough ball proofing-progression measurement system, said inventory of non-frozen pizza dough balls having a particular diversified proofing-mix composition, said dough ball management algorithm periodically outputting dough ball management information, and said dough ball management information causing said worker to modify said particular diversified proofing-mix composition of said inventory of pizza dough balls by moving a prescribed quantity of pizza dough balls at a prescribed point in time from a refrigerated proofing environment to a warm-temperature proofing environment.

28. The combination of an inventory of non-frozen pizza dough balls, a worker, and a computer-based dough ball management algorithm as defined in claim 27, wherein:
said dough ball proofing-progression measurement system involves multiple points of dough ball proofing development including a target point and at least one sub-target point, said algorithm accommodating at least one warm-temperature proofing-time factor and a plurality of variables comprising (a) at least one dough ball usage projection variable and (b) at least one dough ball proofing-point inventory variable.

29. The combination of an inventory of non-frozen pizza dough balls, a worker, and a computer-based dough ball management algorithm as defined in claim 28, wherein:
said multiple points of dough ball proofing development include at least two sub-target points.
